(19) United States
(12) Patent Application Publication
(10) Pub. No.: US 2023/0168080 A1
(43) Pub. Date: Jun. 1, 2023

(54) OPTICAL MEASURING DEVICE AND METHOD FOR ASCERTAINING THE THREE-DIMENSIONAL SHAPE OF AN OBJECT

(71) Applicant: Weber Maschinenbau GmbH Breidenbach, Breidenbach (DE)

(72) Inventor: Bernd KÖSTER, Cremlingen (DE)

(21) Appl. No.: 17/995,434

(22) PCT Filed: Mar. 25, 2021
(86) PCT No.: PCT/EP2021/057762

§ 371 Date: Oct. 4, 2022

(30) Foreign Application Priority Data
Apr. 6, 2020 (DE) 10 2020 109 520.1

(51) Int. Cl. G01B 11/25; G01B 11/06; G01B 11/00; G02B 30/50

(52) U.S. Cl. CPC G01B 11/2522; G01B 11/0608; G01B 11/002; G02B 30/50

(57) ABSTRACT

An optical measuring device (1) for determining the three-dimensional shape of an object (3) is described, which comprises a light section sensor (4) that has an illumination unit (5) configured to project a linear marking (L) onto the object (3) and at least one image acquisition unit (6) for recording the linear marking (L) projected onto the object (3), and comprises a forward increment recording unit that is configured to record the forward increment of the object (3) moved through under the light section sensor (4) as a function of time (t). The optical measuring device (1) is designed to ascertain distance profiles of the object (3) from the linear marking (L). The optical measuring device (1) is designed to record images of the surface of the object (3) which is recorded during the movement of the object (3), to ascertain a displacement of features in the images recorded of the object surface in a time interval, and to determine a displacement of the object (3) in the time interval from the ascertained displacement of the features in the images of the object surface and a measuring scale, derived from the distance profile of the object (3), of the recorded images of the object surface.

The invention relates to an optical measuring device for determining the three-dimensional shape of an object, which comprises at least one light section sensor that has an illumination unit configured to project a linear marking onto the object and at least one image acquisition unit for recording the linear marking projected onto the object, and comprises a forward increment recording unit that is configured to record the forward increment of the object moved through below the light section sensor as a function of time, wherein the optical measuring device is designed to ascertain height profiles of the object from the linear marking.

The invention furthermore relates to a method for determining the three-dimensional shape of an object with such an optical measuring device.

In order to determine object properties, the so-called light section method is known, in which, for example with a laser or line illumination, a line of light is projected onto the surface of the object to be analyzed and the lateral image is acquired with an image acquisition unit. By means of corresponding calibration, the object height of a profile point in the current height profile can then be directly deduced from the shape of the current profile line. A height profile is also referred to as a scan profile, and may also be in the form of a cross-sectional profile.

DE 10 2017 130 909 A1 describes an optical measuring device having a first illumination unit for projecting a linear marking on an illumination plane and a first image acquisition unit for recording the linear marking projected onto the object. A controllable second illumination unit is furthermore provided, which is configured to project light in a predetermined light spectrum onto the object in order to record the light of the second illumination unit reflected back by the object in a position-resolved manner by means of a second image acquisition unit and to determine three-dimensional surface information items of the object by means of a light section with the linear marking and in order to determine properties of the object from the light spectrum, recorded in a position-resolved manner, of the light of the second illumination unit reflected back by the object.

DE 10 2017 104 998 A1 describes a conveyor device and a method for determining the surface velocity of a transport surface.

Since the light section method respectively ascertains 3D data only within the light plane used (=height profile), which corresponds to the line of light that is projected onto the current object surface, external information is required as to the way in which successive height profiles are related to one another, i.e. the way in which the object is moved through the line of light and the distance which exists between the height profiles.

If the sensor is for example moved over the object with a constant velocity, the missing information may be obtained from the movement direction and the magnitude of the velocity.

Often, the measurements are also carried out in such a way that the measurement object lies on a conveyor belt and is moved below a stationary sensor, through the light plane of the latter. The relationship between the individual height profiles can then be obtained from the known transport velocity. If the belt velocity is not constant, particularly when accelerated movements may also take place, measurement errors occur.

When using incremental encoders, which convert the belt movement into signals that respectively correspond to a constant distance, the problem can generally be overcome. If the objects do not adhere securely to the transport medium, however, there may be a slip between the object movement assumed from the increments and the actual object movement. The resulting measurement uncertainty may be amplified by additional belt transitions, where the object behavior during transport is not reliably under control.

In many transport processes that do not use a controlled transport medium, such as slides, roller belts or freefall segments, there are generally no information items relating to the transport path traveled by the measurement object between the height profiles.

Contactless distance and velocity recording with the aid of successive images and a correlation analysis between two successive images is known from EP 2 363 716 A2.

Such a method is encountered in hardware technology implementation, for example in modern PC mice which no longer use a disk but continuously acquire images of the background of the PC mouse with a small CMOS sensor having for instance 16×16 to 30×30 pixels and ascertain the current displacements from the correlation of the image contents of two successive images. The prerequisite, however, is inter alia that the distance substantially does not vary and remains constant on average.

Such a situation generally does not exist in relation to the objects to be scanned by a light section sensor, because in that case the aim of a scanning process is to determine changing surfaces and therefore changing heights and widths.

Even if a sharp image can be generated over the height variations taking place and no significant distance change occurs between two images, and the product surface has enough structures so that successive images of the various distance ranges allow a good correlation analysis, the information relating to the way in which a displacement determined in pixels is related to the actual displacement of the object is missing because the measuring scale of the imaging changes.

On the basis of this, it is an object of the present invention to provide an improved optical measuring device for determining the three-dimensional shape of an object and an improved method for this purpose, which does not have the prerequisite of product transport that takes place in a way which is so controlled that the required path information items can be derived from the transport medium itself.

The object is achieved with the optical measuring device having the features of claim 1 and by the method having the features of claim 14. Advantageous embodiments are described in the dependent claims.

It is proposed for the optical measuring device to be designed to record images of the surface of the object that is recorded during the movement of the object, to ascertain a displacement of features in the recorded images of the object surface in a time interval, and to determine a displacement of the object in the time interval from the respectively ascertained displacement of the features in the images of the object surface, as well as respective distances and measuring scales, derived from at least one height profile of the object, for the recorded images of the object surface.

For this purpose, the respective distance of each surface region recorded as an image may be determined from the cross-sectional profiles for the object surfaces of the object, of which images are recorded for the forward increment determination, and stored as a distance profile for the recorded surface region. If the measuring device is configured in such a way that the respectively registered surface region is intersected centrally by the scan line, the distance of this region may be ascertained particularly easily from the height profile.

The invention uses the fact that a combination of the sequence of depth information items from the height profiles with a sequence of 2D image sensor information items of the object surface leads to a respectively known object movement between the height profiles, because the distance information of the object regions of the acquired 2D images, which is missing in the event of varying distances, can be derived from the height profiles of the light section sensor.

In simple cases, distance-dependent adaptation of the factors for conversion of the pixel displacement in the acquired images in the image space of the object surface into the actual object displacement of the object in the object space may therefore be carried out easily.

This has the advantage that the actual displacement path of the object in the zone of the light section sensor can be detected, without vitiation by slipping or the like taking place, or that simple less controlled transport media, for example slides and roller belts, are also suitable as a measurement segment.

The optical measuring device may have a data processing unit which is designed as a forward increment recording unit to evaluate image sections of the images, recorded by the light section sensor, of the object by ascertaining a displacement of features in the image sections.

The forward increment recording unit may have at least one 2D image sensor which is designed respectively to record images of the surface of the object that is recorded during the movement of the object.

The optical measuring device may be designed to adapt the setting of an objective of the 2D image sensor to quasistatically varying distance ranges between the objective and the object. The objective and/or the illumination may, for example, be automatically adjusted for adaptation to quasistatically different distance ranges (for example differently high products with comparable surface roughness and surface structure).

The forward increment recording unit may have a plurality of 2D image sensors which are respectively designed to record images of the surface of the object that is recorded during the movement of the object. The plurality of 2D image sensors record different surface zones of the object than one another. In this case, the object zones may differ by a different position both in height and in width. For instance, 2D image sensors with the same focus may be aligned at comparably high regions of the object surface which are spatially offset (optionally overlapping) in the same height plane. It is, however, also conceivable for 2D image sensors to have a different focus than one another but to be aligned at the same object region, so that the 2D image sensors record different surface zones in height in relation to the distance between the objective and the respectively focused image plane. The optical measuring device is designed to select respectively one of the plurality of surface zones for the determination of the displacement of the object, while being adapted to height information that is derived from the height profile recorded with the light section sensor.

If the object varies more in width, a 2D image sensor unit (objective and illumination) configured in a fixed fashion may possibly be sufficient in order to ascertain the displacement between two height profiles. Under certain circumstances, more than one object region is required in width for which images are registered, in order to ensure that an image region is always available on the object surface. The suitable image region, or the assigned 2D image sensor, may then be selected from the height profile so that the relevant displacement information can be derived.

The at least one 2D image sensor may be sensitive to a wavelength different than the wavelength of the light section sensor.

It is advantageous for the light of the 2D image sensors to have a different frequency than the line of light of the light section sensor, so that no mutual influence takes place. It may likewise be advantageous if, at different distances, the assigned illuminations for the 2D image sensors likewise use different light frequencies if suitable lighting cannot be found globally for all distance ranges.

The forward increment recording unit may furthermore have an additional illumination unit for the illumination of the recorded surface of the object.

In more complex cases, it is advantageous for adaptation of the illumination, and optionally of the objective of the 2D image sensor, to be carried out from the distance information of the light section sensor.

The optical measuring device may be designed to adapt the illumination of the recorded image zone of the surface of the object to quasistatically varying distance ranges between the objective and the object.

If the object surface varies in basic format but the actual height variation, and therefore the distance of the object region from the 2D image sensor, is limited, quasistatic adaptation of the objective and of the illumination is sufficient. Continual dynamic adaptation does not therefore need to be carried out during the measurement.

The optical measuring device may be designed for dynamic matching of the setting of the objective and of the illumination for distance ranges varying dynamically over the object. For dynamically varying distance ranges, continuous automatic adaptation of the image size and/or object zone lighting of the relevant 2D image sensor may therefore be carried out.

The optical measuring device may be designed to ascertain a displacement of features in the recorded images of the object surface in an image zone that the linear marking intersects. In this case, the middle—as seen in the transport direction—of the surface region of the 2D image sensor for the relevant distance of this object face may lie exactly on a height profile line of the light section sensor. The distance that is obtained from this height profile therefore already approximately represents the average distance of the object region from the relevant 2D image sensor. This may be ensured by a corresponding configuration and arrangement of the optics unit of the 2D image sensor and the scanning optical unit of the light section sensor.

The optical measuring device may be designed to match the scanning frequency of the light section sensor and the image sequence frequency, which is used to determine a displacement of the object from images recorded chronologically in succession, to one another. The matching may, for example, be carried out according to the requirements of the scan resolution, the scan speed or the smoothness of the surface contours.

Since there should be only a small distance change between two images, which is advantageous for the quality of the correlation analysis, the images should be registered with a sufficient image sequence frequency. Particularly if the object surface has only small structural elements, a sufficiently magnified representation of the object zone is advantageous. So that movement of up to a few m/s is also possible in these cases, the acquisition frequency must be selected to be sufficiently high.

For example an object velocity of 1 m/s and an image region of 30×30 pixels, and the smallest structural element of 1 mm, the latter should be sampled with at least two pixels. This gives an object region of 15 mm. If, for a good correlation, it is now assumed that at most a displacement of 7.5 mm should take place between two successive images, an image should be acquired every 7.5 milliseconds, i.e. the image sequence frequency should be at least 134 Hz.

On the other hand, it makes no sense in general to select the frequency to be extremely high, because then, under certain circumstances, no displacement would be measured between two image acquisitions.

The parameters measurement frequency, object zone size, structural element size, maximum velocity and acceleration and smallest resolvable displacement should be matched to one another.

Besides the problem of the measuring scale change when the object distance is not constant, these influencing parameters also mean it cannot be assumed that sharp imaging over the entire height range is sufficient. If an object with a smooth, not very structured surface is taken as an example, merely in order to obtain a correlation between 2 successive overlapping image acquisitions, it is necessary to use relatively strong magnification and small image excerpts so that small structures are sharply visible in the entire image zone and therefore a correlation of the image contents actually works at all. An objective with a large depth of field would in no way achieve the aim. Furthermore, the illumination must on the one hand have a high contrast but on the other hand also be very uniform, since illumination variations and pronounced shadowing variations between two images would be detrimental to the correlation analysis. The factors: structures suitable for correlation, sharpness of the imaging, uniformity of the illumination and no extreme shadowing may be set sufficiently only over a certain working range, which is also dependent on the surface properties of the object.

Adjustments of the objectives of the 2D image sensor and of the associated illumination are thus also advantageous. Alternatively, a suitable selection may be made from a multiplicity of 2D image sensors and/or 2D image sensor regions with distance-dependently configured objectives and illuminations.

The case may be considered in which only quasistatic adaptation is necessary because the changes in the height conditions exist only in the basic format of the measurement objects. It is then sufficient, before the start of the measurement, respectively to adjust the objectives and the illumination automatically to a different working range, the variation then still remaining again being small enough that a correction of the pixel displacement to the true object displacement by distance-dependent scaling is sufficient, or the product varies so slowly in comparison with the object velocity per se that continuous adaptation is possible without problems in terms of time.

If the measurement object has a greater height dynamic range, techniques that allow sufficiently rapid objective adaptation and illumination adaptation are preferably to be used.

In the case of using LEDs, the illumination can generally be adapted more easily since it is possible to switch more simply to other or additional array elements.

An angle variation of the illumination may also be brought about with relatively small deflections, which can be executed rapidly.

For the objectives, automatically adjustable objectives may be used, for example including liquid lenses, so that adaptations may be carried out in the range of a few milliseconds.

If the adaptation does not work rapidly enough during the image acquisition, at least two 2D image sensor units with adjustable objectives and illuminations could for example be provided, one of them measuring while the other is adjusted to the new distance conditions, and the other unit respectively being switched to after the adjustment process. This presupposes that the distance contour for many objects extends relatively continuously—i.e. without abrupt variation in the respective trend.

Also conceivable is a cascade of 2D image sensor units which are pre-adjusted for different distance regions of the surface zones acquired by the forward increment measuring device, which is also economically feasible when economical PC mouse chips are employed.

Through the distance information which is obtained by the light section sensor, the result of that 2D image sensor which best matches the distance respectively determined for each individual one of the plurality of 2D image sensors may then be accessed during the measurement process.

The use of an integrated circuit configured per se for use in an optical mouse, having an image sensor designed to record an image pixel matrix and having an image evaluation unit for recording the displacement of features with the aid of the image comparison of image pixel matrices recorded chronologically in succession, is advantageous. The optical measuring device may in this case be designed to scale the displacement with the aid of the measuring scale profile derived from the distance profile, and to ascertain the forward increment of the object from the scaled displacement.

For example, a plurality of units—with adapted illuminations and objectives—such as are used for example in mice for personal computers (PCs) could be employed as image sensors.

In some cases, however, a CMOS camera which is provided anyway for information about frequency-selective information items—for example object color—could also be suitable, for example in order to find particular features such as defects on the object surface, suitable subregions of this acquisition sensor being used in order to obtain a pixel displacement in the x and y directions from the aforementioned correlation analyses, which is then converted while being scaled suitably on the basis of the distance information from the light section sensor to form path information in x and y.

The optical device may have a data memory with distance-dependent correlation parameters and scaling parameters stored in the data memory, and be designed to convert the ascertained displacement of the features in the images of the object surface with correlation parameters and/or scaling parameters read from the data memory into a displacement path of the object.

The object is furthermore achieved with a method for determining the three-dimensional shape of an object with such an optical measuring device. In this case, the following steps are provided:
ascertaining a height profile of an object conveyed through below the light section sensor with the light section sensor with the aid of a linear marking projected onto the object,
recording images of the object surface,
ascertaining a displacement of features in the recorded images of the object surface, and
determining a displacement of the object from the ascertained displacement of the features in the images of the object surface and from respective distances and measuring scales, derived from the height profile of the object, of the recorded images of the object surface.

Adaptation of an optics unit and/or illumination unit of the optical measuring device as a function of the height profile, respectively derived with the light section sensor, for the recorded zones of the object surface of the object may be provided in the method.

Advantageously, selection of one of a plurality of 2D image sensors and/or driving of an illumination unit of the optical measuring device in order to illuminate the recorded object surface as a function of the distance profiles, derived with the light section sensor from the height profiles of the object, for the 2D image regions with their assigned illumination elements is carried out.

It is conceivable for the principle of combining height information, 2D image information and pixel displacement with the aid of the correlation analysis to be implemented by a compact hardware unit that uses contactless distance measurement (light time-of-flight, ultrasound, etc.) in order to adapt the imaging optical unit in real time.

The illumination may be carried out globally, for example as telecentric illumination, the expected return beam intensity of which is adapted position-dependently and incorporated as a parameter into the correlation calculation, so that a permanently distance-corrected displacement path in x and y is output by this expanded hardware.

Also conceivable is a suitably driven LED array, which must be externally provided for the hardware, the array being configured in such a way that lighting highly suitable for the correlation analysis is obtained at each distance. In this case, however, adaptation to the object contour can be carried out only within certain limits. Abrupt holes or elevations could then be processed expediently by means of certain filter mechanisms.

It is conceivable to carry out a kind of averaging over a certain contour of the object in the scan direction. In this way, implausible distance measures and implausible displacement measures of an individual measurement may be expediently eliminated in a simple manner.

A special variant could also include the depth images of two light section sensors, which have a known fixed distance D from one another in the scan direction and which measure with a known identical scanning frequency, in the correlation analysis. In this case, the number of height profiles until there is a correlated overlap zone would be the measure of the velocity that the object has needed to cover the segment D and therefore the measure of the segment that lies between two height profiles.

The invention will be explained in more detail below with the aid of an exemplary embodiment with the appended drawings, in which:

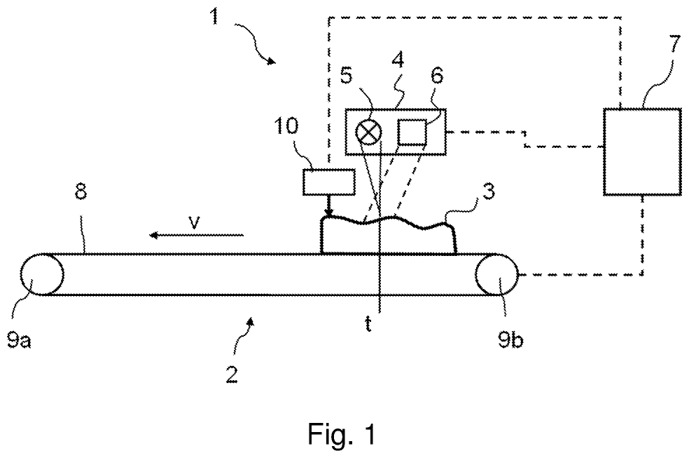

FIG. 1—shows a diagram in side view of an optical measuring device on a conveyor belt for objects transported through below a light section sensor;

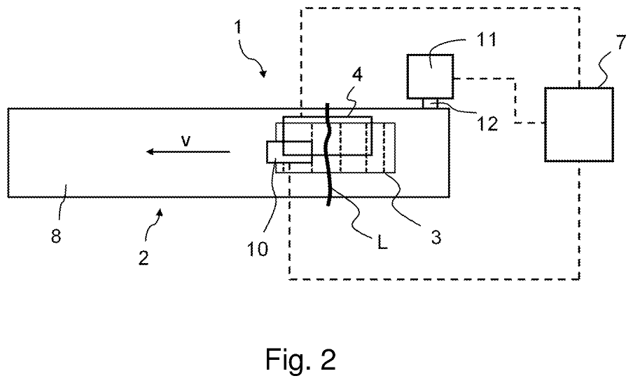

FIG. 2—shows a diagram in plan view of an optical measuring device on a conveyor belt for objects transported through below a light section sensor.

FIG. 1 shows a diagram in side view of an optical measuring device 1 that is arranged on a conveyor belt 2. The optical measuring device 1 is aligned at the upper side of the conveyor belt 2, on which objects 3 are conveyed below a light section sensor 4 in a forward increment direction V.

The light section sensor 4 has an illumination unit 5 that is configured to project a linear marking onto the surface of the object 3 facing toward the light section sensor 4. The light section sensor 4 furthermore has at least one image acquisition unit 6 for recording at least a part of the linear marking projected onto the object.

The light section sensor 4 or a data processing unit 7 connected thereto is designed, for example by suitable programming with a computer program configured to run on the data processing device 7, in order to ascertain the respective height of the object 3 in relation to the upper side 8 of the conveyor belt 2 with the aid of the acquired images with the linear marking on the object 3, in an image column, which then provides a surface profile or a cross-sectional profile of the object 3 for each scan image. Features such as object width, object height and cross section are also obtained from this height profile. If the object height is determined at a particular location transversely to the transport direction, this provides a distance profile at this location via the sum of height profiles, i.e. over time or over the place along the length of the object 3. In this way, for object zones on the object 3 that are recorded for example by the forward increment measuring unit, their respective height value may also be ascertained, from which it is also possible to ascertain the imaging measuring scale that is to be taken into account in order to convert from a displacement in the image to a displacement of the associated object surface.

For the forward increment movement, the conveyor belt 2 is guided on two deflection rollers 9a, 9b arranged at a distance from one another and, for example, driven by means of the data processing unit 7. For the determination of the distance profile during the forward displacement movement V, it is now desirable to determine the forward increment of the object 3 as accurately as possible as a function of time t.

For this purpose, a forward increment recording unit is provided, which in the exemplary embodiment comprises at least one 2D image sensor 10 designed to detect images of the surface of the object 3 moving through below the light section sensor 4. For this purpose, the 2D image sensor 10 acquires images of sections of the surface of the object 3. The displacement path of the object 3 is ascertained from an image comparison of features of two successively acquired images of the surface of the object 3. In this case, the displacement of identical features in the pair of images is recorded. The forward increment velocity may then be determined by taking into account the time difference of the acquisition of the successive images, i.e. by the time derivative of the displacement.

The optical measuring device 1 may have a data processing unit 7 that carries out the image comparison and the determination of the displacement path and optionally the forward increment velocity from the result of the image comparison. For this purpose, it is possible to use the images of the at least one 2D image sensor 10 or images that have been acquired by the image acquisition unit 6 of the light section sensor 4.

It is conceivable for images of a 2D image sensor 10 to be transmitted to the data processing unit 7. The determination of the displacement path, or of the forward increment velocity, from the successive images is then carried out by a computer program executed by the data processing unit 7.

The data processing unit 7 may be designed respectively to derive a measuring scale from the height information items recorded with the light section sensor 4 at particular instants t, this being used to ascertain the displacement of the object 3 from the displacement of features of the images of the object surface. The measuring scale may, for this purpose, for example be a scaling factor with which the displacement of a feature in the image is respectively multiplied. The distance-dependent scaling measuring scale transforms the displacement determined in the image space into the actual displacement of the object 3 in the object space.

FIG. 2 shows a plan view of the optical measuring device 1 and the conveyor belt 2, on which objects 3 are transported through below the light section sensor 4. It can be seen that a linear marking L is projected onto the surface of the object 3. The height profile can be ascertained from the deformation of the linear marking L.

In this diagram, the forward increment sensor 10 is aligned at the surface of the object 3.

It can also be seen that the conveyor belt 2 is driven by means of a motor 11, which is connected by means of a shaft 12 to a deflection roller 9b. The motor 11 is driven by the data processing unit 7, which not only evaluates—but also undertakes control functions. It is also conceivable for the object 3 to be moved on a roller belt with or without a drive.

The peaks and troughs of the object 3, i.e. a particular distance profile, are indicated by the dashed lines on the object 3.

From the shape of the current linear marking L, the object height of a profile point in the current sectional image can be deduced directly by means of corresponding calibration. If the object 3 is moved along below the linear marking L with a spatially and temporally known forward increment, a sequence of height profiles is obtained, from which the surface of the object 3 facing toward the light section sensor 4 can be reconstructed.

The forward increment V is determined with an optical path measurement by using an imaging 2D image sensor 10 that acquires images of the surface, moving with a forward increment velocity, of the object 3 with a sufficient image sequence frequency, at least two successive images being compared with one another and the current displacement value being ascertained from the displacement of the image information items.

For this purpose, the data processing unit 7 is configured, for example, to evaluate the images acquired during the movement of the surface of the object 3, which respectively contain overlapping information items, by means of a correlation analysis of the successive image contents. If the image contents are in this case displaced relative to one another, the size of the correlation is obtained when the image contents match optimally. The displacement vector of the image contents for this state with optimal correlation then corresponds to the displacement path.

The 2D image sensor 10 may be integrated in a commercially available compact sensor. For this purpose, integrated circuits that are used in optical mice for computers and contain the optics unit with an image acquisition unit and an evaluation unit are obtainable.

It is conceivable for the forward increment recording unit with the 2D image sensor 10 additionally to have an illumination unit (light source) that lights the surface to be recorded of the object 3 suitably and as uniformly as possible.

It is also advantageous for the 2D image sensor 10 to contain an optics unit which generates a flat image, optimally usable for the correlation analysis, in a manner suited to the distance conditions and the surface consistency (material, roughness, structuredness, etc.).

The 2D image sensor 10 is preferably designed for the average surface property of the object 3. For this purpose, both the optics unit and an optional illumination of the forward increment recording unit may be rigidly adjusted or regulated. It is advantageous in this case for the optics unit and the illumination of the 2D image sensor 10 to be matched to the average distance of the 2D image sensor 10 from the surface of the object 3 in a fixed manner or preferably dynamically as a function of the varying conditions of for example distance, light, surface structure, etc.

The measurement frequency of the 2D image sensor 10 should be at least high enough that a large depth change does not take place for two successive images.

It is conceivable for the optics unit and illumination of the 2D image sensor 10 to be variably adaptable to the surface consistency and the separation of the 2D image sensor 10 from the background. For the case in which differences in the average distances and in the average surface consistency exist between different applications, i.e. the average distance of the 2D image sensor 10 from the surface of the object 3 varies or the structure of the surface is finer or coarser, the path measurement may be adapted to the other conditions. This ensures that a flat structured image, which is optimally suitable for the correlation analysis, can respectively be acquired by the 2D image sensor 10.

The measurement frequency of the 2D image sensor 10 is preferably variably adaptable. It may, for example, be synchronized by the data processing unit 7 with a control signal defining the forward increment velocity of the conveyor belt 2.

It is conceivable for the image acquisition unit 6 of the light section sensor 4 to be used simultaneously as an image acquisition unit for the forward increment recording unit.

The optical measuring device 1 may be designed in such a way that, in the event of pronounced height variations, adaptation of the optics unit and the illumination is carried out on the basis of depth data that have been measured by the 2D image sensor 10 or the light section sensor 4. For determining the forward increment, it is sufficient for there to be piecewise constant surface structures and distances from the surface of the object 3. Over the entire measurement segment, the path measurement may therefore be carried out with sufficient accuracy if adaptation as a function of the depth data is performed whenever the distances of the acquired images from the object surfaces vary so greatly that adaptation of the imaging measuring scale is necessary.

The adaptation is preferably carried out automatically, and may be performed by the data processing unit 7.

The height information items, or distance data, determined with the light section sensor 4 may be used to computationally correlate the result data of the path measurement carried out with the forward increment determination unit. In this way, for example, a scaling factor may be ascertained from the height information items determined with the light section sensor 4, which is then incorporated into the forward increment of the object 3 determined with the forward increment determination unit 10 from the displacement of features of the surface of an object 3 that is recorded with images.

The measurement method may also be carried out in such a way that, in the event of an unchanged surface structure, a pure distance change and the modified scaling associated therewith of the image acquired by the 2D image sensor 10 is subsequently corrected by means of software by the separation, known by the light section sensor 4, of the acquisition zone of the image acquisition unit 6. A large distance means, for the same pixel displacement from the correlation analysis, a larger difference segment between the two successive image acquisitions. If calculation is carried out with a constant distance and thus with a constant path scaling in the first calculation step, the data may be recalculated with the aid of the indexing carried out and the correct distances and therefore the correct scaling factors may be used to correct the previously determined path differences. This retrospectively gives the true path segment, i.e. the forward increment, despite varying distancing of the 2D image sensor 10 from the surface.

Correction factors, which may be derived from the measurement of the at least one light section sensor 4, may directly be sent to or ascertained by the data processing unit 7, which then outputs immediately corrected position displacements.

For the case in which only a simple scaling change is to be considered, the current distance value or the distance change may be transmitted continuously to expanded correlation hardware that continuously takes the scaling change to be evaluated into account and ascertains and outputs a corrected displacement value in real time.

1. An optical measuring device for determining a three-dimensional shape of an object, comprising:
at least one light section sensor comprising an illumination unit configured to project a linear marking onto the object;
at least one image acquisition unit for recording the linear marking projected onto the object;
a forward increment recording unit configured to record a forward increment of the object moved relative to the at least one light section sensor as a function of time,
wherein the optical measuring device is designed to ascertain height profiles of the object from the linear marking,
wherein the optical measuring device is designed to record images of a surface of the object that is recorded during the movement of the object to ascertain a displacement of features in a plurality of recorded images of the surface of the object in a time interval, and
wherein the optical measuring device is designed to determine a displacement of the object in the time interval from one or more of
the displacement of the features in the images of the surface of the object ascertained from recorded images of the surface of the object recorded during the movement of the object,
distances and measuring scales derived from at least one height profile of the object for the plurality of recorded images of the surface of the object.

2. The optical measuring device as claimed in claim 1, wherein the forward increment recording unit comprises a data processing unit to evaluate image sections of the images recorded by the at least one light section sensor, wherein the data processing unit is used when ascertaining the displacement of features in the plurality of images.

3. The optical measuring device as claimed in claim 1, wherein the forward increment recording unit comprises a two dimensional image sensor designed to record images of the surface of the object during the movement of the object.

4. The optical measuring device as claimed in claim 3, wherein the optical measuring device is designed to adapt a setting of an objective of the two dimensional image sensor to quasistatically varying distance ranges between the objective and one or more surface zones of the object which are used by the forward increment recording unit.

5. The optical measuring device as claimed in claim 1, wherein the forward increment recording unit comprises a plurality of two dimensional image sensors, each of which are designed to record images of the surface of the object during movement of the object, wherein the plurality of two dimensional image sensors each record different surface zones of the object relative to one another, and wherein the optical measuring device is designed to select one of the plurality of surface zones for the determination of the displacement of the object on the basis of height information items relating to all surface zones recorded by the plurality of two dimensional image sensors which are derived from height profiles recorded with the at least one light section sensor.

6. The optical measuring device as claimed in claim 1 further comprising at least one two dimensional image sensor sensitive to a wavelength different than a wavelength of the at least one light section sensor.

7. The optical measuring device as claimed in claim 1 wherein the forward increment recording unit comprises an additional illumination unit for the illumination of a recorded surface of the object.

8. The optical measuring device as claimed in claim 1, wherein the optical measuring device is designed to adapt illumination of a recorded image zone of the surface of the object to quasistatically varying distance ranges between an objective and a plurality of surface zones of the object which are used by the forward increment recording unit.

9. The optical measuring device as claimed in claim 8, wherein the optical measuring device is designed for dynamic adaptation of
a setting of the objective, and
the illumination for distance ranges, which vary dynamically over the object, of the plurality of surface zones used for forward increment determination.

10. The optical measuring device as claimed in claim 1 wherein the optical measuring device is designed to ascertain a displacement of features in a plurality of recorded images of the surface of the object in an image zone that the linear marking intersects.

11. The optical measuring device as claimed in claim 1 wherein the optical measuring device is designed to match a scanning frequency of the at least one light section sensor and an image sequence frequency used to determine a displacement of the object from images recorded chronologically in succession to one another.

12. The optical measuring device as claimed in claim 1 wherein the optical measuring device comprises
an integrated circuit configured for use in an optical mouse,
an image sensor designed to record an image pixel matrix, and
an image evaluation unit for recording the displacement of features using image comparison of image pixel matrices recorded chronologically in succession,
wherein the optical measuring device is designed to scale the displacement of features, wherein scaling is recorded by the image evaluation unit using a measuring scale derived from at least one height profile, in order to ascertain the object displacement taking place.

13. The optical measuring device as claimed in claim 1 further comprising a data memory with distance-dependent correlation parameters and scaling parameters stored in the data memory, and wherein the optical measuring device is designed to convert an ascertained displacement of features in the plurality of recorded images of the surface of the object with correlation parameters and/or scaling parameters read from the data memory into a displacement path of the object.

14. A method for determining a three-dimensional shape of an object with an optical measuring device as claimed in claim 1, comprising:
ascertaining a height profile of an object conveyed by the at least one light section sensor using a linear marking projected onto the object,
recording images of a surface of the object,
ascertaining a displacement of features from a plurality of recorded images of the surface of the object, and
determining a displacement of the object from an ascertained displacement of the features in the images of the surface of the object, and from distances and measuring scales derived from a height profile of the object obtained from the plurality of recorded images of the surface of the object.

15. The method as claimed in claim 14, further comprising adaptation of an optics unit and/or illumination unit and/or image sequence frequency of the optical measuring device as a function of a distance for a recorded zone of the surface of the object which is derived from the height profile recorded with the at least one light section sensor.

16. The method as claimed in claim 14 further comprising selecting a two dimensional image sensor and/or driving of an illumination unit of the optical measuring device in order to illuminate a recorded object surface as a function of the distances derived with the at least one light section sensor from the height profiles of the object, for two dimensional image regions with assigned illumination elements.
